(19) United States
(12) Patent Application Publication
(10) Pub. No.: US 2008/0021245 A1
(43) Pub. Date: Jan. 24, 2008

(54) Process for recovering phosphorus ligands from metal complexes having phosphine ligands

(76) Inventors: Bjorn Schlummer, Bonn (DE); Ulrich Scholz, Mulheim a.d.Ruhr (DE); Laszlo Majoros, Satoraljaujhely (HU); Nikolaus Risch, Lemgo (DE)

Correspondence Address: LANXESS CORPORATION, 111 RIDC PARK WEST DRIVE, PITTSBURGH, PA, 15275-1112, US

(21) Appl. No.: 11/716,914

(22) Filed: Mar. 12, 2007

(30) Foreign Application Priority Data
Mar. 15, 2006 (DE) 10 2006 011 867.7

(51) Int. Cl. C07F 9/02

(52) U.S. Cl. 568/9

(57) ABSTRACT

A process is described for recovering phosphine ligands from transition metal complexes which have been used in homogeneously catalysed reactions and contain phosphine ligands, in which a) the reaction mixture which remains after a homogeneously catalysed reaction has ended is contacted with an oxidizing agent. b) the reaction mixture is then extracted with an organic solvent which is insoluble with the reaction mixture to remove the transition metal oxide formed and then c) the oxidized phosphine ligand is isolated from the organic solvent removed from the reaction mixture.

The invention relates to a process for recovering phosphorus ligands, especially homogeneous catalyst systems, in which metal complexes having phosphine ligands are used.

Compounds which have one or more phosphorus atoms as a coordination site for metals as a structural feature play an important role as ligands in a multitude of catalytic processes. Particularly in the field of homogeneous catalysis, a variety of phosphorus ligands has been developed for controlling the reactivity and selectivity of metal-catalysed reactions. When they have one or more chiral centres, a catalytic reaction can also be utilized for formation of enantiomerically enriched target molecules. Important examples of homogeneously catalysed processes in which phosphorus ligands are used include hydrogenations, C—C cross-coupling reactions (Heck, Suzuki, Kumada, Negishi, Hayashi reaction), C—N bond formation reactions (Buchwald-Hartwig amination), 1,4addition reactions and many others. A characteristic feature for the ligands used in these transformations is their often complex base structure, so that multistage complicated syntheses are required for the preparation of these ligands, in particular in the case of highly active systems. For industrial use, this means that the ligand used constitutes a significant cost driver of the process in question. The recovery of the ligand used is therefore highly desirable. For the solution of this problem, various procedures are described in the literature.

It is possible in principle to distinguish between three different strategies:
1. Chemical modification of the ligands to be used by functionalization with anchor groups by which the physical properties of the ligand for a recovery are positively influenced. These include, for example, the class of water-soluble sulphonated ligand systems, ligand systems which bear functional groups for anchoring on a suitable resin, and fluorinated ligand systems which can be recovered relatively easily by the use of specific solvent systems. Disadvantages of this strategy are the change in the structure of the ligand, which entails a more complicated synthesis, and the often significantly lower activity of the functionalized ligand in the catalytic reaction.

Literature examples can be found in the following publications:
S. Saffarzadeh-Matin, C. J. Chuck, F. M. Kerton, C. M. Rayner Organometallics; 2004; 23, 22; 5176-5181 describe the use of poly(dimethylsiloxane)-functionalized phosphines.
G.-J. Deng, B. Yi, Y.-Y. Huang. W.-J. Tang, Y.-M. He, Q.-H. Fan Adv. Synth. & Cat. 2004. 346, 12, 1440-1444 describe the use of BINAP which has been incorporated chemically into a dendrimer structure.
Köllhofer, H. Plenio, Chemistry Eur. J. 2003, 9, 6, 1416-1425 describe the use of polyethylene glycol-bonded phosphines for Sonogashira couplings.
B. Pugin, H. Landert, F. Spindler, H.-U. Blaser, Adv. Synth. & Cat. 2002, 344, 9, 974-979 describe the use of immobilized Xyliphos ligands. The immobilization is done by anchoring the ligand functionalized with an amino group to silica gel or polystyrene resins.
T. Ohkuma, H. Takeno, Y. Honda, R. Noyori Adv. Synth. & Cat. 2001, 343, 4, 369-375 describe the use of derivatized BINAP ligands which are bonded to polystyrene resin beads by a linker.
P. Guerreiro. V. Ratovelomanana-Vidal, J.-P. Genet, P. Dellis Tetrahedron Lett. 2001. 42, 20, 3423-3426 describe the use of BINAP derivatives which have been functionalized by polyethylene glycol or a guanidinium salt unit.
E. Genin, R. Amengual, V. Michelet, M. Savignac, A. Jutand, L. Neuville, J.-P. Genet. Adv. Synth. & Cat. 2004, 346, 13-15, 1733-1741 describe the use of sulphonic acid-bearing triphenyphosphine derivatives and their recovery by using aqueous systems.

What is common to all of these methods is the complicated synthesis of the ligand functionalized for the purpose of recovery. Furthermore, the catalytic activity of the particular ligand is in most cases lowered by the functionalization.
2. Use of non-classical solvent systems. In this case, new reaction media, for example ionic liquids, supercritical carbon dioxide or supercritical water, and also thermomorphic systems, are used. Disadvantages of this strategy are the use of reaction media which are expensive in comparison to organic solvents, the changed reactivity in the reaction media used, possible contamination of the product by them, the problem of disposing of the reaction media and necessary technical changes in the process when supercritical systems are used. Moreover, for this method too, functionalized ligand structures with different physical parameters are often needed to be able to perform the reaction.

Literature examples can be found in the following publications:
H. L. Ngo, A. Hu, W. Lin, Tetrahedron Lett. 2005, 46, 4, 595-597 describe the use of BINAP which has been functionalized with two phosphonic acid groups in ionic liquids.
B. Pugin, M. Studer, E. Kuesters, G. Sedelmeier, X. Feng, Adv. Synth. & Cat. 2004, 346, 72, 1481-1486 describe the use of phosphine ligands in multiphasic systems composed of water and ionic liquids.
R. P. J. Bronger, S. M. Silva, P. C. J. Kramer, P. W. N. M. van Leeuwen, Chem. Comm. 2002. 24, 3044-3045 describe the synthesis of a phenoxaphosphine-modified ligand which additionally bears imidazolium salt groups. This ligand may be used in ionic liquids.
P. Wasserscheid, W. Keirn, Angew. Chem. 2000, 112, 3926-3945 describe, in a review article the use of ionic liquids as a reaction medium for homogeneous catalysis processes.
W. Leitner, Pure & Appl. Chem. 2004, 76, 3, 635-644 describes, in a review article, the use of supercritical carbon dioxide for the immobilization of catalysts.
R. H. Fish, Chem. Eur. J. 1999, 5, 6, 1677-1680 describes, in a review article, the use of fluorinated solvents for a multiphasic catalysis with fluorine-functionalized ligands.

What is common to all of these methods is the use of non-classical solvents, which entail a change to existing processes in organic solvents. Furthermore, the ligands used in most cases have to be functionalized, in order to adjust physical parameters, for example solubility, in the particular non-classical solvent.
3. The least-described strategy comprises the recovery of a ligand which has not been. functionalized for the recovery and exhibits the highest activity in the reaction optimization using classical solvent systems, for example organic solvents. Advantages of this strategy are the avoidance of process adaptations resulting from the recovery, the use of the most active ligand in classical reaction media and reusability, which is unlimited in, principle, of the recovered ligand.

Approaches to this can be found in the following publications:
J. L. Marugg, M. L. Neitzel, J. Tucker, Tetrahedron Lett. 2003, 7537-7540 describe a “catch and release” strategy for (o-biphenyl)(t-butyl)₂P. In this case, the phosphine ligand is drawn onto the solid phase by protonation with sulphonic acid immobilized on polystyrene resin or on silica gel. The subsequent release is effected with ammonia in methanol. >3 equivalents of the immobilized sulphonic acid are needed for complete protonation. Moreover, this methodology is generally restricted to strongly basic phosphines which can be protonated by sulphonic acids. The great majority of the phosphine ligands used for homogeneous catalysis do not have these strongly basic properties at the phosphorus centre.
B. H. Lipshutz, B. Frieman, H. Birkedal, Org. Lett. 2004, 6, 14, 2305-2308 describe the complexation of phosphine ligands in reaction mixtures with copper(T) chloride. The insoluble complex precipitates out. Reaction with dithiolate derivatives recomplexes the copper and releases the appropriate phosphine. The disadvantage of this methodology is the use of the toxicologically controversial metal copper, and also possible losses of partly oxidized phosphines which no longer form the desired copper complex. Furthermore, a purification step is not provided in the method arid is not trivial as a result of the isolation of the sensitive free phosphine.
B. H. Lipshutz, P. A. Blomgren, Org. Lett. 2001, 3, 12, 1869-1871 describe the isolation of phosphines from reaction mixtures with high-loading chloromethylated polystyrene using sodium iodide in acetone. The method is described for the, recovery of triphenylphosphine. The triphenylphosphonium iodide salt formed, which is bonded covalently to the resin, is cleaved by lithium aluminium hydride to release triphenylphosphine. The resin formed is not directly reusable. Disadvantages of this methodology are the restriction to phosphines which enter into the desired alkylation reaction with the resin, the lack of a purification step for the sensitive free phosphine and the formation of large amounts of phosphonium iodides in the solid phase, which is undesirable in process technology terms. Moreover, the use of lithium aluminium hydride for the cleavage in the scale-up is undesirable from a safety and economic point of view.
A. Falchi, M. Taddei, Org. Lett. 2000, 2, 22, 3429-3431 describe the removal of triphenylphosphine and triphenylphosphine oxide by reaction with polyethylene glycol-linked chlorinated triazine derivatives. Recycling of the ligands and removal of the covalently bonded phosphines is not described. Disadvantages are the use of the complex and expensive triazine derivative, the restriction to triphenylphosphine and the lack of possible regeneration of the phosphine.

The published methods for recovering phosphine ligands have the described disadvantages of the modification of already optimized ligand structures, use of non-classical solvent systems which require an adjustment of existing processes, or the use of complicated scavenging reagents. In addition, the number of recycling cycles as a result of decrease in the activity of, for example, solid phase-bound ligands is an inherent problem.

It is an object of the present invention to provide a process with which the phosphine ligands can be removed in a technically simple and economically viable manner from the metal complexes with phosphine ligands used in the homogeneous catalysis, and this removal must not chemically change the ligands in such a way that they can no longer be regenerated.

### BRIEF DESCRIPTION OF THE DRAWINGS

FIG. 1 illustrates a recovery course according to the present inventions.

It has now been found that, surprisingly, metal complexes with pbosphine ligands in reaction mixtures, mother liquors and distillation bottoms can be cleaved by simple treatment with oxidizing agents such as oxygen, sulphur or selenium, and the corresponding phosphine ligands can b obtained as oxides, sulphides or selenides. The purification of these derivatives in oxidized form is easily possible by recrystallization. The reduction to the corresponding free phosphines, whose quality corresponds to that of the originally used phosphines, is likewise possible easily by known reduction methods.

The invention therefore provides a process for recovering phosphine ligands from transition metal complexes which have been used in homogeneously catalysed reactions and contain phosphine ligands, in which
a) the reaction mixture which remains after a homogeneously catalysed reaction has ended is contacted with an oxidizing agent,
b) the reaction mixture is then extracted with an organic solvent which is insoluble with the reaction mixture to remove the transition metal oxide formed and then
c) the oxidized phosphine ligand is isolated from the organic solvent removed from the reaction mixture.

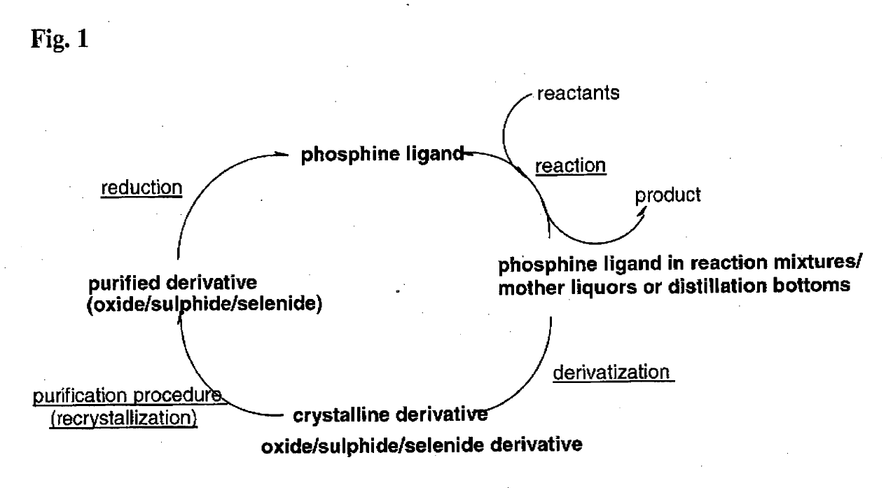

The advantages of this methodology are the use of cheap derivatizing reagents, the avoidance of expensive nonclassical solvents, the simple implementation in existing industrial plants and the use of a modifications which cannot be avoided, of the ligand used or of the already optimized catalytic process. Since the ligand, after workup, can be recovered in equal quality in the original form, an infinite number of recycling cycles is possible in principle. FIG. 1 shows the course of the recovery in schematic form.

Examples of homogeneously catalysed processes whose reaction residues comprising these catalysts can be recovered in accordance with the invention are hydrogenations, C—C cross-coupling reactions (Heck, Suzuki, Kumada, Negishi, Hayashi reactions), C—N bond formation reactions (Buchwald-Hartwig amination), 1,4-addition reactions. Preference is given to recovering the ligands of the catalysts from hydrogenations.

The process can in principle be applied to all phosphine ligands of the general formula 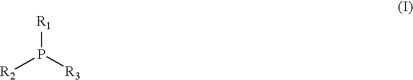
where R₁, R₂ and R₃ arc preferably each independently C₁-C₈-alkyl, aryl, arylalkyl, which may each independently bear suitable substituents, for example Cl, Br, I, F, C₁-C₈-alky, aryl, arylalkyl. NO₂. halogen.

Examples of such phosphine ligands include Cl-MeO-BIPHEP, BINAP, JOSIPHOS, the phosphine ligands which are known to those skilled in the art and are summarized in a large number of review articles and books, which have suitably modified alkyl or aryl radicals as substituents on the phosphorus atom and are used for the coordination of transition metals in catalytic reactions.

The phosphine ligand is preferably 5,5′dichloro-6,6′-dimethoxy-2,2′-bis(diphenylphosphino)-1,1′-biphenyl.

Typically, these phosphine ligands are ligands of a transition metal complex. Examples of such transition metals are ruthenium, rhenium, palladium, platinum. Preference is given to ruthenium.

The phosphorus ligand used for a catalytic process may, after performance of the catalytic reaction, be present in mother liquors, distillation bottoms or wash phases. The process includes the treatment of these reaction residues with an oxidizing agent.

The oxidizing agents used may be oxygen-containing oxidizing agents such as hydrogen peroxide, sodium hypochlorite, halogen oxide derivatives, for example molecular oxygen, including in diluted form in gases, for example in air or metal oxides. Preference is given to hydrogen peroxide and sodium hypochlorite, particular preference to hydrogen peroxide. It is also possible for other elements of the 6th main group of the Periodic Table to serve as oxidizing agents, in this case, preference is given to sulphur or selenium, particular preference to sulphur.

The crude phosphine derivative obtained by treatment of the reaction residues with a suitable oxidizing agent is extracted from the solution by extraction with an organic solvent, for example halogenated hydrocarbons such as dichloromethane or ethers, for example dibutyl ether, alcohols, aromatic compounds, for example toluene, in order to remove the oxidized metal oxides which have likewise formed from the desired phosphine ligand.

Thereafter, the filtrate can either be freed of the solvent used and exchanged for a solvent suitable for the purification by recrystallization, for example halogenated hydrocarbons, ethers, alcohols, aromatic compounds, or the recrystallization can be effected directly from the filtrate.

The highly pure phosphine derivative thus obtained can be converted, for example, to the desired phosphine ligands by methods known to those skilled in the art with a reducing agent, for example hydrogen or halogenated silanes, for example trichlorosilane.

### EXAMPLES:

1. Recovery of 5,5′-dichloro-6,6′dimethoxy-2,2′-bis(diphenylphosphino)-1,1′-biphenyl (abbreviated hereinafter to: Cl-MeO-BIPHEP) with S/C ratio=100

0.073 g (0.08 mmol) of [RuBr₂-Cl-MeO-BIPHEP] and 1.0 ml (8.0 mmol) of ethyl acetoacetate as the substrate to be hydrogenated were initially charged in 10 ml of degassed methylcyclohexane as a solution in a 125 ml VA autoclave. The hydrogenation was performed at 110° C. and under a pressure of 50 bar with a reaction time of 4 h.

After decompression, the reaction solution was distilled to remove the product. The distillation bottoms were taken up in 10 ml of dichloromethane and 1 ml of hydrogen peroxide solution (35% in water) was added. The reaction mixture was stirred at room temperature for 1 h. 25 ml of water were then added. The organic phase was removed and the solvent was removed under reduced pressure. 3 ml of dibutyl ether were added to the residue and the suspension was heated to 140° C. for 2 h. Thereafter, the reaction mixture was cooled and the ruthenium oxide formed was filtered off. The solvent of the filtrate was removed under reduced pressure. 0.0308 g (0.045 mmol) of Cl-MeO-BIPHEP bis-oxide was obtained. This corresponds to a recovery of 56% of theory.

³¹P NMR=29.04 ppm (Corresponds to Reference Material)

2. Recovery of 5,5′-dichloro-6,6′-dimethoxy-2,2′-bis(diphenylphosphino)-1,1′-biphenyl (abbreviated hereinafter to: Cl-MeO-BIPHEP) with S/C ratio=10

0.730 g (0.80 mmol) of [RuBr₂-Cl-MeO-BIPHEP] and 1.0 ml (8.0 mmol) of ethyl acetoacetate as the substrate to be hydrogenated were initially charged in 60 ml of degassed methylcyclohexane as a solution in a 125 ml VA autoclave. The hydrogenation was performed at 110° C. and under a pressure of 50 bar with a reaction time of 4 h.

After decompression, the reaction solution was distilled to remove the product. The distillation bottoms were taken up in 10 ml of dichloromethane and l ml of hydrogen peroxide solution (35% in water) was added. The reaction mixture was stirred at room temperature for 1 h. 25 ml of water were then added. The organic phase was removed and the solvent was removed under reduced pressure. 3 ml of dibutyl ether were added to the residue and the suspension was heated to 140° C. for 2 h. Thereafter, the reaction mixture was cooled and the ruthenium oxide formed was filtered off. The solvent of the filtrate was removed under reduced pressure. 0.355 g (0.52 mmol) of Cl-MeO-BIPHEP bis-oxide was obtained. This corresponds to a recovery of 63% of theory.

³¹P NMR=29.04 ppm (Corresponds to Reference Material)

1. Process for recovering phosphine ligands from transition metal complexes which have been used in homogeneously catalysed reactions and contain phosphine ligands, in which
a) the reaction mixture which remains after a homogeneously catalysed reaction has ended is contacted with an oxidizing agent,
b) the reaction mixture is then extracted with an organic solvent which is insoluble with the reaction mixture to remove the transition metal oxide formed and then
c) the oxidized phosphine ligand is isolated from the organic solvent removed from the reaction mixture.

2. Process according to claim 1, wherein that the phosphine ligand has the genera formula 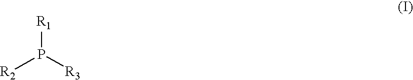
where R₁, R₂ and R₃ are each independently C₁-C₈-alkyl, aryl, arylalkyl, which may each independently have substituents from the group of Cl, Br, I, F, C₁-C₈-alkyl, aryl, arylalkyl, NO₂. halogen, alkoxy- and aryloxy.

3. Process according to claim 1, wherein that the oxidizing agents used are hydrogen peroxide, sodium hypochlorite, molecular oxygen, halogen oxide derivatives, sulphur or selenium.

4. Process according to claim 1, wherein that the organic solvent insoluble with the reaction mixture is a halogenated hydrocarbon such as dichloromethane, an ether such as dibutyl ether, an alcohol or an aromatic compound such as toluene.

5. Process according to claim 1, wherein that the transition metal in the transition metal complex is ruthenium, palladium, rhenium or platinum.

6. Process according to claim 1, wherein that the oxidized phosphine ligand is isolated by recrystallization from the organic solvent.

7. Process according to claim 1, wherein that the phosphine ligand is 5,5′-dichloro-6,6′-dimethoxy-2,2′-bis(diphenylphosphino)-1,1′-biphenyl.

8. Process according to claim 1, wherein that the oxidized phosphine ligand is returned back to its original form by treatment with a reducing agent.

9. Process according to claim 8, wherein that the reducing agent is hydrogen or a halogenated silane.
